(19) United States
(12) Patent Application Publication
(10) Pub. No.: US 2017/0164278 A1
(43) Pub. Date: Jun. 8, 2017

(54) METHOD, APPARATUS, AND SYSTEM FOR ADJUSTING THE BRIGHTNESS OF DISPLAY SCREEN, AND TRANSMITTING DATA

(71) Applicants: Le Holdings (Beijing) Co., Ltd., Beijing (CN); LEMOBILE INFORMATION TECHNOLOGY (BEIJING) CO., LTD., Beijing (CN)

(72) Inventor: Xiaofei Fang, Beijing (CN)

(73) Assignees: Le Holdings (Beijing) Co., Ltd., Beijing (CN); LEMOBILE INFORMATION TECHNOLOGY (BEIJING) CO., LTD., Beijing (CN)

(21) Appl. No.: 15/240,566

(22) Filed: Aug. 18, 2016

Related U.S. Application Data
(63) Continuation of application No. PCT/CN2016/088949, filed on Jul. 6, 2016.

(30) Foreign Application Priority Data
Dec. 8, 2015 (CN) 201510898422.X

(51) Int. Cl. H04W 52/02; H04W 4/12; H04M 1/725; H04L 12/46; H04W 4/00; H04W 4/02

(52) U.S. Cl. CPC H04W 52/027; H04W 4/008; H04W 4/021; H04M 1/7253; H04M 1/72533; H04L 12/4633; H04W 4/12

(57) ABSTRACT

Embodiments of the disclosure provide a method, apparatus, and system for adjusting the brightness of a display screen, and transmitting data so as to address the problem in the prior art of being operationally complex to adjust the brightness of a display screen of a display device to thereby save power consumption of the display device while enabling the user to watch comfortably. The method for adjusting the brightness of a display screen includes: receiving ambient illumination data transmitted by a user equipment with which a communication connection is set up, wherein the ambient illumination data are acquired by the user equipment using an optical sensor; and adjusting the brightness of the display screen according to the received ambient illumination data.

### CROSS-REFERENCE TO RELATED APPLICATIONS

This application is a continuation of International Application No. PCT/CN2016/088949, filed on Jul. 6, 2016, which claims priority to Chinese Patent Application No. 201510898422.X, filed with the Chinese Patent Office on Dec. 8, 2015, both of which are hereby incorporated by reference in their entireties.

### FIELD OF TECHNOLOGY

Embodiments of the present disclosure relate to the field of display technologies and particularly to a method, apparatus, and system for adjusting the brightness of a display screen, and transmitting data.

### BACKGROUND

Smart TV sets are provided with fully open platforms on which there are operating systems so that their users can install and uninstall software, game, and other programs available from third-party providers to thereby extend constantly the functions of the TV sets, and they can access the Internet over network cables and wireless networks, which has become a popular trend of TV sets.

As can be apparent, the smart TV sets have advantages unexpected for traditional TV sets. However the inventors have identified during making of the disclosure that the smart TV sets may not have the brightness of their display screens adjusted smartly as compared with the traditional TV sets, but have the brightness of the display screens adjusted similarly to the traditional TV sets, where the users open a menu using remote controllers, and adjust the brightness of the display screens manually by selecting one of menu options; or the users adjust the brightness of the display screens manually using control buttons on TV panels, thus making it operationally complex to adjust the brightness of the display screens of the existing smart TV sets. On the other hand, if the brightness of the display screens is different, then power consumption of the smart TV sets will be different, so it is highly desirable in the prior art to address a technical problem of how to save power consumption of the smart TV sets while enabling the users to watch comfortably.

### SUMMARY

Embodiments of the disclosure provide a method, apparatus, and system for adjusting the brightness of a display screen, and transmitting data so as to address the problem in the prior art of being operationally complex to adjust the brightness of a display screen of a display device to thereby save power consumption of the display device while enabling the user to watch comfortably.

In a first aspect, some embodiments of the disclosure provide a method for adjusting the brightness of a display screen, the method includes: receiving ambient illumination data transmitted by a user equipment with which a communication connection is set up, wherein the ambient illumination data are acquired by the user equipment using an optical sensor; and adjusting the brightness of the display screen according to the received ambient illumination data.

In a second aspect, some embodiments of the disclosure provide an apparatus for adjusting the brightness of a display screen, the apparatus includes: at least one processor; and a memory communicably connected with the at least one processor for storing instructions executable by the at least one processor, wherein execution of the instructions by the at least one processor causes the at least one processor to
receive ambient illumination data transmitted by a user equipment with which a communication connection is set up, wherein the ambient illumination data are acquired by the user equipment using an optical sensor; and
adjust the brightness of the display screen according to the ambient illumination data.

In a third aspect, some embodiments of the disclosure provide a method for transmitting data, the method includes: acquiring ambient illumination data using an optical sensor; encapsulating the ambient illumination data into a data message; and transmitting the data message to a display device with which a communication connection is set up.

In a fourth aspect, some embodiments of the disclosure provide an apparatus for transmitting data, the apparatus includes: at least one processor; and a memory communicably connected with the at least one processor for storing instructions executable by the at least one processor, wherein execution of the instructions by the at least one processor causes the at least one processor to
acquire ambient illumination data using an optical sensor;
encapsulate the ambient illumination data into a data message; and
transmit the data message to a display device with which a communication connection is setup.

### BRIEF DESCRIPTION OF THE DRAWINGS

In order to make the technical solutions according to the embodiments of the disclosure or in the prior art more apparent, the drawings to which a description of the embodiments or the prior art refers will be briefly introduced below, and apparently the drawings to be described below are merely illustrative of some of the embodiments of the disclosure, and those ordinarily skilled in the art can derive from these drawings other drawings without any inventive effort. In the drawings:

FIG. 1 is a schematic structural diagram of a system for adjusting the brightness of a display screen according to some embodiments of the disclosure;

FIG. 2 is a flow chart of a method for adjusting the brightness of a display screen according to some embodiments of the disclosure;

FIG. 3 is a schematic flow chart of an implementation of a method, performed by a display device, for adjusting the brightness of a display screen according to some embodiments of the disclosure;

FIG. 4 is a schematic flow chart of an implementation of a method for transmitting data according to some embodiments of the disclosure;

FIG. 5 is a schematic structural diagram of an apparatus for adjusting the brightness of a display screen according to some embodiments of the disclosure;

FIG. 6 is a schematic structural diagram of an apparatus for transmitting data according to some embodiments of the disclosure;

FIG. 7 is a schematic structural diagram of another apparatus for adjusting the brightness of a display screen according to some embodiments of the disclosure;

FIG. 8 is a schematic diagram of a first computer readable storage medium according to some embodiments of the disclosure;

FIG. 9 is a schematic structural diagram of another apparatus for transmitting data according to some embodiments of the disclosure; and

FIG. 10 is a schematic diagram of a second computer readable storage medium according to some embodiments of the disclosure.

### DETAILED DESCRIPTION OF THE EMBODIMENTS

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

### First Embodiment

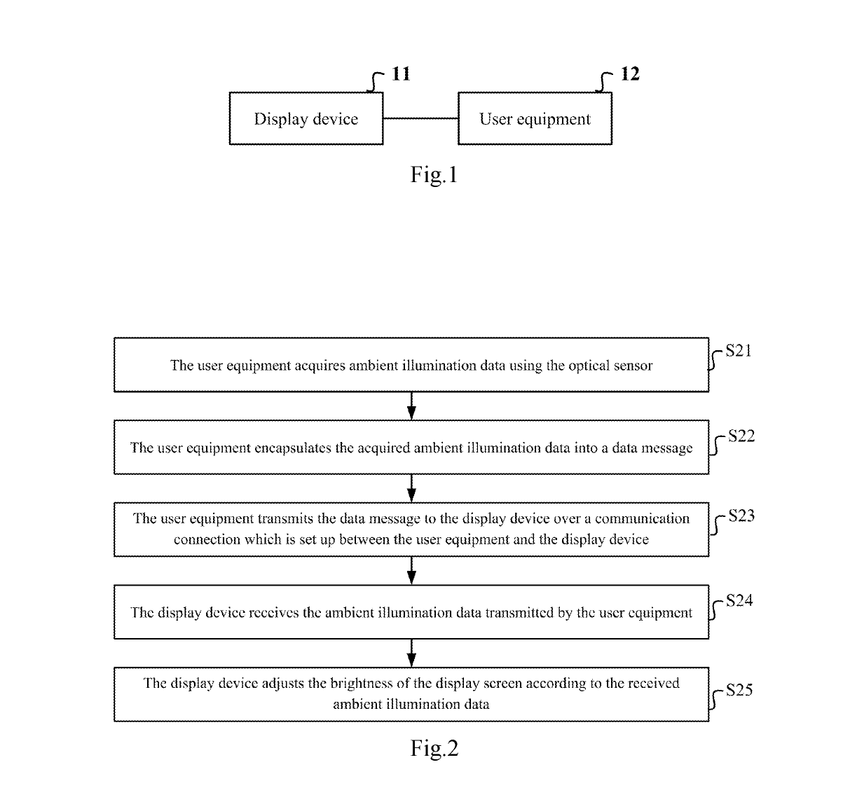

As illustrated in FIG. 1, there is a schematic structural diagram of a system for adjusting the brightness of a display screen according to some embodiments of the disclosure, where the system includes a display device 11 and a user device 12, where the display device 11 includes an apparatus for adjusting the brightness of a display screen, and the user device 12 including an apparatus for transmitting data.

In a implementation, the display device 11 can set up a communication connection with the user device 12, where the communication connection between them can be a local area network communication connection, that is, the display device 11 and the user device 12 are located in the same local area network, or the communication connection between them can alternatively be a short-distance communication connection, for example, the display device 11 can set up a Bluetooth communication connection with the user device 12 through Bluetooth pairing. If the display device 11 is connected with the user device 12 in a Bluetooth communication mode, then the display device 11 and the user equipment 12 can set up the Bluetooth communication connection in the following flow: the display device 11 and the user device 12 enable their Bluetooth function, and then scan for Bluetooth devices nearby, and locate each other, where the display device 11 can transmit a Bluetooth pairing request to the user device 12, or the user equipment 12 can transmit a Bluetooth pairing request to the display device 11, to request for setting up Bluetooth communication, and the display device 11 can set up the Bluetooth communication connection with the user equipment 12 upon acceptance by each other.

In a implementation, the display device 11 as referred to in the embodiment of the disclosure can include but will not be limited to a smart TV set, a Personal Computer (PC), or another device including a display screen, and the user equipment 12 can include but will not be limited to a handset, a tablet computer, a wearable device, or another portable device in which an optical sensor is installed.

A method for adjusting the brightness of a display screen according to an exemplary embodiment of the disclosure will be described below with reference to FIG. 2 together with FIG. 1, and as illustrated in FIG. 2, the method can include the following steps:

S21. The user equipment acquires ambient illumination data using the optical sensor.

The user equipment can acquire the ambient illumination data periodically according to preset data. If it is time to acquire data, then the user equipment will acquire the ambient illumination data using the optical sensor. For example, if a data acquisition periodicity is preset at 30 minutes, then the user equipment will acquire the ambient illumination data once every 30 minutes.

Of course, the user equipment can alternatively be triggered to acquire the ambient illumination data, upon sensing a change to an ambient illumination environment, but the embodiment of the disclosure will not be limited thereto.

The user equipment can monitor a change in ambient illumination using the optical sensor installed in the user equipment, and be triggered to acquire the ambient illumination data, upon detecting a change in ambient illumination.

S22. The user equipment encapsulates the acquired ambient illumination data into a data message.

S23. The user equipment transmits the data message to the display device over a communication connection which is set up between the user equipment and the display device.

If the user equipment and the display device are located in the same local area network, then the user equipment will transmit the data message to the display device by broadcasting the data message thereto; and if the user equipment sets up a Bluetooth communication connection with the display device, then the user equipment will transmit the data message to the display device over the Bluetooth communication connection which is set up.

S24. The display device receives the ambient illumination data transmitted by the user equipment.

In a implementation, the display device listens to the communication link which is set up between the display device and the user equipment after setting up the communication connection with the user equipment, and receives the data message transmitted by the user equipment over the communication link upon detecting the data message to obtain the ambient illumination data therein.

S25. The display device adjusts the brightness of the display screen according to the received ambient illumination data.

The display device adjusts the brightness of the display screen according to the ambient illumination data carried in the received data message.

### Second Embodiment

In order to avoid the brightness of the display screen of the display device from being adjusted inaccurately due to a significant difference between an environment where the user equipment is located, and an environment where the display device is located, for example, the user equipment and the display device are located in the same local area network but in different rooms in which illumination varies differently, so that the ambient illumination data transmitted by the user equipment to the display device may not apply to the display device, and if the display device adjusts the brightness of the display screen according to the received ambient illumination data, then there may be an error as a result. In order to improve the precision of the method for adjusting the brightness of a display screen. Before the step S25, the display device can further firstly measure the distance between the display device and the user equipment, and determine whether the measured distance is not above a preset distance threshold, and if so, then the flow will proceed to the step S25; otherwise, the display device will maintain the current brightness of the display device.

In a implementation, the display device can measure the distance between the display device and the user equipment through Bluetooth ranging, or the display device can measure the distance between the display device and the user equipment using an infrared distance sensor, an optical distance sensor, or an ultrasonic distance sensor built therein, etc., but the embodiment of the disclosure will not be limited thereto. After the distance between the display device and the user equipment is determined, the display device determines whether the distance is above a preset distance threshold, and if so, then the display device will determine that the received ambient illumination data are validated, and maintain the current brightness of the display screen; otherwise, the display device will determine that the received ambient illumination data are validated, and adjust the brightness of the display screen according to the received ambient illumination data.

Here the distance threshold can be preset by a user for a real application scenario.

### Third Embodiment

If the user equipment acquires the ambient illumination data periodically according to the preset data acquisition periodicity, then since the ambient illumination data acquired in different data acquisition periodicities may be identical, if the user equipment transmits the ambient illumination data to the display device upon acquisition thereof without taking their difference into account. If the ambient illumination data acquired in the current periodicity are the same as or slightly different from the ambient illumination data acquired in the last periodicity so that the display device may not adjust the brightness of the display screen, but the user equipment still encapsulates and then transmits the acquired ambient illumination data to the display device, then on one hand, transmission resources between the user equipment and the display device will be wasted; and on the other hand, the display device will response to the ambient illumination data transmitted by the user equipment, thus wasting processing resources of the display device.

In order to save the transmission resources between the user equipment and the display device, and the processing resources of the display device, in some embodiments of the disclosure, before the step S22, the user equipment can firstly determine whether the difference between the currently acquired ambient illumination data and the lastly acquired ambient illumination data is above a preset difference threshold, and if so, then the flow will proceed to the step S22; otherwise, the step S22 will be skipped, but the user equipment does not acquire the ambient illumination data using the optical sensor until a next time for acquiring data comes.

In the method for adjusting the brightness of a display screen according to the embodiments of the disclosure, the user equipment monitors a change in ambient illumination, and acquires and then transmits the ambient illumination data to the display device, so that the display device can adjust the brightness of the display screen according to the received ambient illumination data to thereby simplify the operations of adjusting the brightness of the display screen; and on the other hand, the user equipment acquires the ambient illumination data in real time, so that the display device can adjust the brightness of the display screen to the real illumination environment to thereby save power consumption of the display device while enabling the user to watch comfortably. Moreover no optical sensor will be installed in the display device to thereby lower a hardware cost of the display device. Furthermore in the embodiments of the disclosure, before the brightness of the display screen is adjusted, the display device can further firstly determine whether the distance between the user equipment and the display device lies in a preset distance range, and if so, the display device will adjust the brightness of the display screen according to the received ambient illumination data; otherwise, the display device will not adjust the brightness of the display screen, thus improving the precision of adjusting the brightness of the display screen. Before the ambient illumination data are transmitted to the display device, the user equipment can firstly determine whether the difference between the currently acquired data and the lastly acquired data is above the preset difference threshold, and if so, then the user equipment will encapsulate and then transmit the ambient illumination data; otherwise, the user equipment will wait for the next time to acquire data, thus lowering an overhead of the processing resource of the display device while saving the transmission resources between the user equipment and the display device.

Based upon the same inventive idea, embodiments of the disclosure further provide a method and apparatus, implemented by a display device, for adjusting the brightness of a display screen, and a method and apparatus, implemented by a user equipment, for transmitting data, and since these methods and apparatuses address the problem under a similar principle to the method above for adjusting the brightness of a display screen, reference can be made to the implementation of the method above for implementations of these methods and apparatuses, so a repeated description thereof will be omitted here.

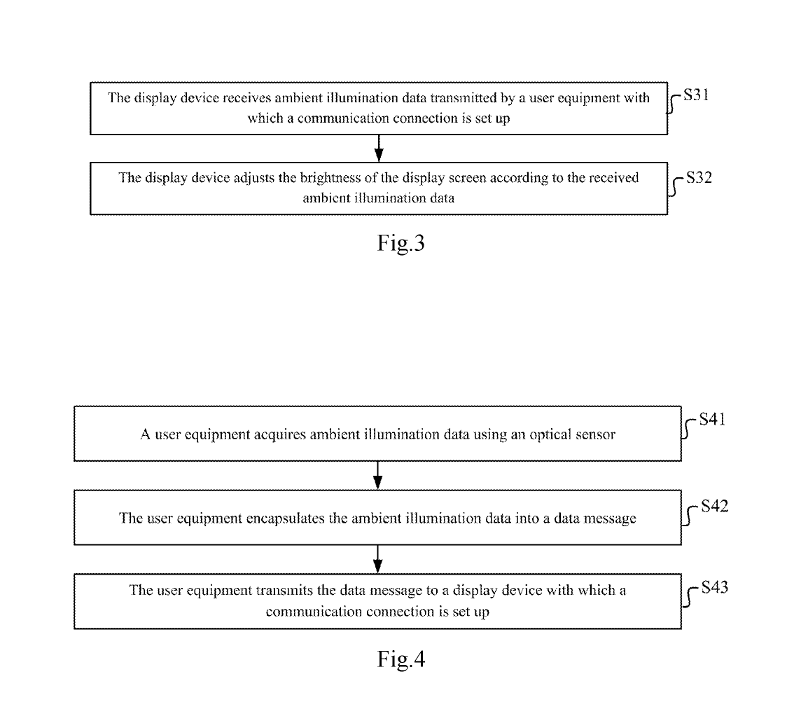

As illustrated in FIG. 3, there is a schematic flow chart of an implementation of a method, performed by a display device, for adjusting the brightness of a display screen according to some embodiments of the disclosure, where the method can include the following steps:

S31. The display device receives ambient illumination data transmitted by a user equipment with which a communication connection is set up.

Here the ambient illumination data are acquired by the user equipment using an optical sensor. The communication connection between the display device and the user equipment can be a local area network communication connection or a short-distance communication connection, and if the communication connection is a local area network communication connection, then the step S31 can be performed in such a way that the display device receives the ambient illumination data transmitted by the user equipment with which the local area network communication connection is set up, using a broadcast message.

S32. The display device adjusts the brightness of the display screen according to the received ambient illumination data.

Before the step S32, the method can further include the steps of: measuring by the display device the distance between the display device and the user equipment; determining whether the distance is not above a preset distance threshold; and if so, then adjusting the brightness of the display screen according to the received ambient illumination data; otherwise, maintaining the current brightness of the display device.

Here the display device can measure the distance between the display device and the user equipment through Bluetooth ranging.

As illustrated in FIG. 4, there is a schematic flow chart of an implementation of a method for transmitting data according to some embodiments of the disclosure, where the method can include the following steps:

S41. A user equipment acquires ambient illumination data using an optical sensor.

S42. The user equipment encapsulates the ambient illumination data into a data message.

S43. The user equipment transmits the data message to a display device with which a communication connection is set up.

Here the communication connection between the user equipment and the display device can be a local area network communication connection or a short-distance communication connection, and if the communication connection is a local area network communication connection, then the user equipment will transmit the data message to the display device with which a communication connection is set up, by broadcasting the data message thereto.

Before the ambient illumination data are encapsulated into the data message, the user equipment can further include the steps of: determining by the user equipment whether the difference between the currently acquired ambient illumination data and the lastly acquired ambient illumination data is above a preset difference threshold; and if so, then encapsulating the ambient illumination data into the data message; otherwise, not acquiring the ambient illumination data using the optical sensor until a next time for acquire data comes.

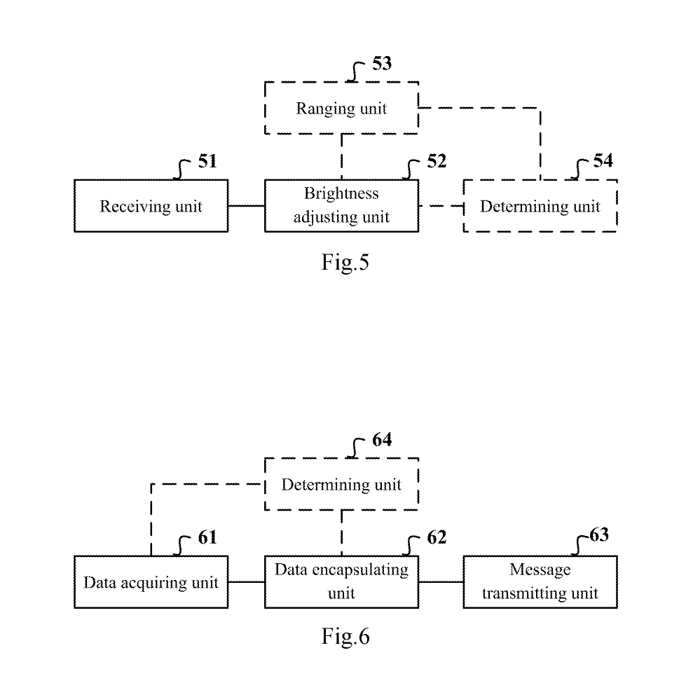

As illustrated in FIG. 5, there is a schematic structural diagram of an apparatus for adjusting the brightness of a display screen according to some embodiments of the disclosure, where the apparatus can include:

A receiving unit 51 is configured to receive ambient illumination data transmitted by a user equipment with which a communication connection is set up, where the ambient illumination data are acquired by the user equipment using an optical sensor.

Here the communication connection is a local area network communication connection or a short-distance communication connection; and

The receiving unit 51 is configured to receive the ambient illumination data transmitted by the user equipment with which the local area network communication connection is set up, using a broadcast message.

A brightness adjusting unit 52 is configured to adjust the brightness of the display screen according to the ambient illumination data received by the receiving unit.

The apparatus for adjusting the brightness of a display screen according to some embodiments of the disclosure can further include a ranging unit and a determining unit, where:

The ranging unit 53 is configured to measure the distance between the display device and the user equipment before the brightness adjusting unit 52 adjusts the brightness of the display screen according to the received ambient illumination data;

The determining unit 54 is configured to determine whether the distance measured by the ranging unit 53 is not above a preset distance threshold; and

The brightness adjusting unit 52 is configured, if a result of the determination by the determining unit 54 is positive, to adjust the brightness of the display screen according to the received ambient illumination data; and if the result of the determination by the determining unit 54 is negative, to maintain the current brightness of the display screen.

Here the ranging unit 53 is configured to measure the distance between the display device and the user equipment through Bluetooth ranging.

As illustrated in FIG. 6, there is a schematic structural diagram of an apparatus for transmitting data according to some embodiments of the disclosure, where the apparatus can include:

A data acquiring unit 61 is configured to acquire ambient illumination data using an optical sensor;

A data encapsulating unit 62 is configured to encapsulate the ambient illumination data acquired by the data acquiring unit into a data message; and

A message transmitting unit 63 is configured to transmit the data message to a display device with which a communication connection is set up.

Here the communication connection is a local area network communication connection or a short-distance communication connection.

The message transmitting unit 63 is configured to transmit the data message to the display device with which the local area network communication connection is set up, by broadcasting the data message thereto.

The apparatus for transmitting data according to some embodiments of the disclosure can further include a determining unit 64 configured:

Before the data encapsulating unit encapsulates the ambient illumination data into the data message, to determine whether the difference between the currently acquired ambient illumination data and the lastly acquired ambient illumination data is above a preset difference threshold;

The data encapsulating unit 62 is configured, if a result of the determination by the determining unit is positive, to encapsulate the ambient illumination data into the data message; and

The data acquiring unit 61 is further configured, if the result of the determination by the determining unit is negative, not to acquire the ambient illumination data using the optical sensor until a next time for acquiring data comes.

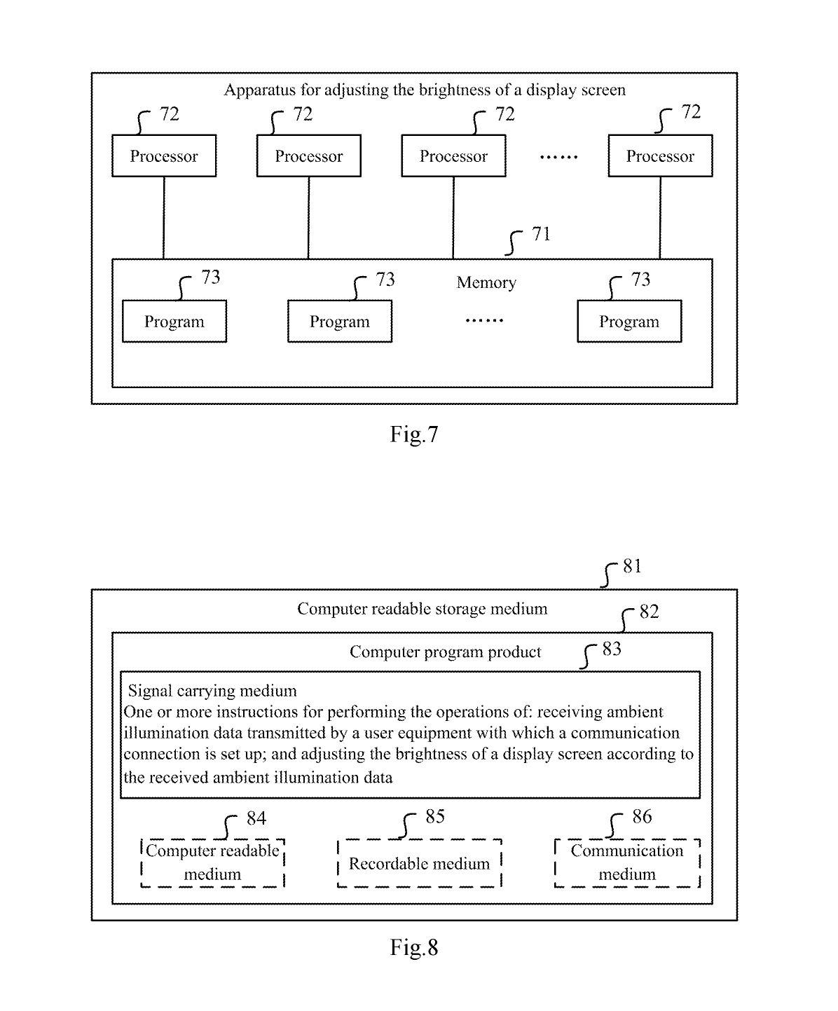

As illustrated in FIG. 7, there is a schematic structural diagram of another apparatus for adjusting the brightness of a display screen according to some embodiments of the disclosure, where the apparatus includes a memory 71, one or more processors 72, and one or more programs 73, where the one or more programs 73 are configured, upon being executed by the one or more processors 72, to perform the operations of: receiving ambient illumination data transmitted by a user equipment with which a communication connection is set up, where the ambient illumination data are acquired by the user equipment using an optical sensor; and adjusting the brightness of the display screen according to the received ambient illumination data.

Some embodiments of the disclosure further provide a computer readable storage medium on which there are stored computer executable instructions configured to be executed by an apparatus for adjusting the brightness of a display screen to perform the operations of: receiving ambient illumination data transmitted by a user equipment with which a communication connection is set up, where the ambient illumination data are acquired by the user equipment using an optical sensor; and adjusting the brightness of the display screen according to the received ambient illumination data.

As illustrated in FIG. 8, a computer readable storage medium 81 stores thereon a computer program product 82 which can include any combination of one or more readable medium, e.g., a signal carrying medium 83, a computer readable medium 84, a recordable medium 85, a communication medium 86, etc., where the signal carrying medium 83 stores therein one or more instructions for performing the operations of: receiving ambient illumination data transmitted by a user equipment with which a communication connection is set up; and adjusting the brightness of a display screen according to the received ambient illumination data.

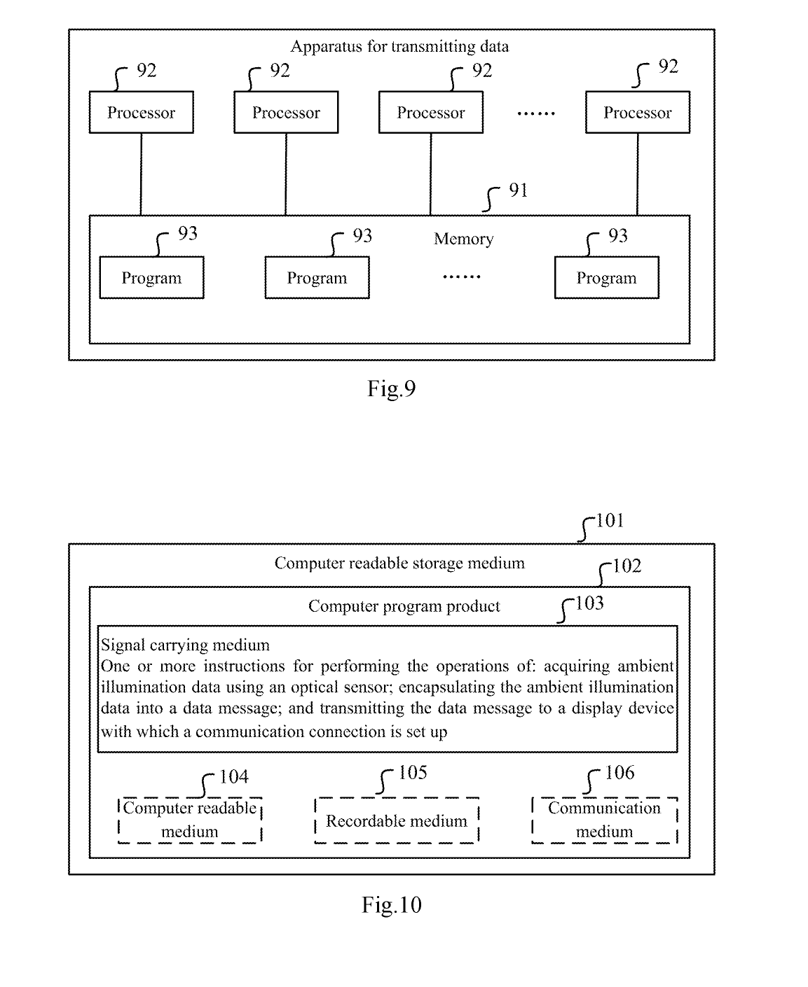

As illustrated in FIG. 9, there is a schematic structural diagram of another apparatus for transmitting data according to some embodiments of the disclosure, where the apparatus includes a memory 91, one or more processors 92, and one or more programs 93, where the one or more programs 93 are configured, upon being executed by the one or more processors 92, to perform the operations of: acquiring ambient illumination data using an optical sensor; encapsulating the ambient illumination data into a data message; and transmitting the data message to a display device with which a communication connection is set up.

Some embodiments of the disclosure further provide another computer readable storage medium on which there are stored computer executable instructions configured to be executed by an apparatus for transmitting data to perform the operations of: acquiring ambient illumination data using an optical sensor; encapsulating the ambient illumination data into a data message; and transmitting the data message to a display device with which a communication connection is set up.

As illustrated in FIG. 10, a computer readable storage medium 101 stores thereon a computer program product 102 which can include any combination of one or more readable medium, e.g., a signal carrying medium 103, a computer readable medium 104, a recordable medium 105, a communication medium 106, etc., where the signal carrying medium 103 stores therein one or more instructions for performing the operations of: acquiring ambient illumination data using an optical sensor; encapsulating the ambient illumination data into a data message; and transmitting the data message to a display device with which a communication connection is set up.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the steps in the methods according to the embodiments described above can be performed by software together with necessary universal hardware platform, and of course by hardware. The aforementioned technical solutions or a part of the technical solutions making a contribution to the prior art can be in form of software product which can be stored in a computer readable storage medium, such as a ROM, a RAM, a magnetic disc, an optical disk etc, and can include some instructions to make a computer equipment (such as a PC, a server or a network equipment) program the steps of method in each of the embodiments or some parts of the embodiments

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

1-15. (canceled)

16. A method for adjusting brightness of a display screen of a display device, the method comprises:
receiving ambient illumination data transmitted by a user equipment with which a communication connection is set up, wherein the ambient illumination data are acquired by the user equipment using an optical sensor; and
adjusting the brightness of the display screen according to the received ambient illumination data.

17. The method according to claim 16, wherein before adjusting the brightness of the display screen according to the received ambient illumination data, the method further comprises:
measuring a distance between the display device and the user equipment;
determining whether the distance is not beyond a preset distance threshold; and
if the distance is not beyond a preset distance, adjusting the brightness of the display screen according to the received ambient illumination data; otherwise,
maintaining a current brightness of the display device.

18. The method according to claim 17, wherein measuring the distance between the display device and the user equipment comprises:
measuring the distance between the display device and the user equipment through a Bluetooth ranging.

19. The method according to claim 16, wherein the communication connection is a local area network communication connection or a short-distance communication connection; and
if the communication connection is the local area network communication connection, then the receiving the ambient illumination data transmitted by the user equipment with which the communication connection is set up comprises:
receiving the ambient illumination data transmitted by the user equipment with which the local area network communication connection is set up through using a broadcast message.

20. An apparatus for adjusting brightness of a display screen, the apparatus comprises:
at least one processor; and
a memory communicably connected with the at least one processor for storing instructions executable by the at least one processor, wherein execution of the instructions by the at least one processor causes the at least one processor to:
receive ambient illumination data transmitted by a user equipment with which a communication connection is set up, wherein the ambient illumination data are acquired by the user equipment using an optical sensor; and
adjust the brightness of the display screen according to the ambient illumination data.

21. The apparatus according to claim 20, wherein the execution of the instructions by the at least one processor further causes the at least one processor to:
measure a distance between the display device and the user equipment before the adjusting the brightness of the display screen according to the received ambient illumination data;
determine whether the distance is not beyond a preset distance threshold; and
adjust the brightness of the display screen according to the received ambient illumination data, if a result of the determination is positive; and maintain a current brightness of the display screen, if the result of the determination is negative.

22. The apparatus according to claim 21, wherein the measure a distance between the display device and the user equipment comprises:
measure the distance between the display device and the user equipment through a Bluetooth ranging.

23. The apparatus according to claim 20, wherein the communication connection is a local area network communication connection or a short-distance communication connection; and
the receive ambient illumination data transmitted by a user equipment with which a communication connection is set up comprises:
receive the ambient illumination data transmitted by the user equipment with which the local area network communication connection is set up through using a broadcast message.

24. A method for transmitting data, the method comprising:
acquiring ambient illumination data using an optical sensor;
encapsulating the ambient illumination data into a data message; and
transmitting the data message to a display device with which a communication connection is setup.

25. The method according to claim 24, wherein before encapsulating the ambient illumination data into the data message, the method further comprises:
determining whether the difference between a currently acquired ambient illumination data and a lastly acquired ambient illumination data is beyond a preset difference threshold; and
if a result of the determination is positive, then encapsulating the ambient illumination data into the data message, and
if the result of the determination is negative, then not acquiring the ambient illumination data using the optical sensor until a next time for acquiring data comes.

26. The method according to claim 24, wherein the communication connection is a local area network communication connection or a short-distance communication connection; and
if the communication connection is the local area network communication connection, then the transmitting the data message to the display device with which the communication connection is set up comprises:
transmitting the data message to the display device with which the local area network communication connection is set up, by broadcasting the data message thereto.

27. An apparatus for transmitting data, the apparatus comprises: at least one processor; and
a memory communicably connected with the at least one processor for storing instructions executable by the at least one processor, wherein execution of the instructions by the at least one processor causes the at least one processor to
acquire ambient illumination data using an optical sensor;
encapsulate the ambient illumination data into a data message; and
transmit the data message to a display device with which a communication connection is set up.

28. The apparatus according to claim 27, wherein the execution of the instructions by the at least one processor further causes the at least one processor to:
before the data encapsulating unit encapsulates the ambient illumination data into the data message, determine whether a difference between a currently acquired ambient illumination data and a lastly acquired ambient illumination data is beyond a preset difference threshold;
if a result of the determination is positive, encapsulate the ambient illumination data into the data message; and
if the result of the determination is negative, not acquire the ambient illumination data using the optical sensor until a next time for acquiring data comes.

29. The apparatus according to claim 27, wherein the communication connection is a local area network communication connection or a short-distance communication connection; and
the transmit the data message to a display device with which a communication connection is set up comprises: transmit the data message to the display device with which the local area network communication connection is set up by broadcasting the data message thereto.
